(19) United States
(12) Patent Application Publication
(10) Pub. No.: US 2016/0052523 A1
(43) Pub. Date: Feb. 25, 2016

(54) APPARATUS AND METHOD OF USE FOR AN ALCOHOL TEST UNIT

(71) Applicants: John Ruocco, Mastic, NY (US); Ronald A. Koppel, Moriches, NY (US)

(72) Inventors: John Ruocco, Mastic, NY (US); Ronald A. Koppel, Moriches, NY (US)

(21) Appl. No.: 14/834,926

(22) Filed: Aug. 25, 2015

Related U.S. Application Data
(60) Provisional application No. 62/041,256, filed on Aug. 25, 2014.

(51) Int. Cl. B60W 40/08; H04W 4/02

(52) U.S. Cl. CPC B60W 40/08; H04W 4/02; B60W 2040/0836

(57) ABSTRACT

A portable apparatus for the receipt and analysis of a breath-carried component, such as alcohol, includes a sensor module for receiving breath samples of a subject and detecting the presence of the component to be monitored; a module for monitoring and determining the location of the apparatus; a module for the acquisition of characteristics of the subject providing the sample and processing them into a form that allows comparison to a database of individuals and their characteristics; a control module coupling and controlling the other modules of the apparatus into a operable system; and a power supply. A wireless communication module is provided to transmit data associated with a sample, the subject providing the sample, and the location of the apparatus to a remote receiver for further analysis, processing and/or storage. The apparatus may be used in a vehicle for driver breath monitoring or may be carried by an individual to allow sampling to be performed at various locations.

The present invention is directed to an apparatus that can serve as both a portable testing apparatus and an automotive interlock device capable of monitoring and detecting a variety of compounds the presence of which in the human body is capable of being detected by an analysis of a person's breath.

### BACKGROUND OF THE INVENTION

The analysis of a human breath for the presence of various compounds is well known. Perhaps the most common use for such technology is for the monitoring and measurement of consumed alcohol. Such devices are typically installed in vehicles to allow for the monitoring of alcohol in the driver's breath, which can be converted to a blood alcohol level which in turn is a determination of whether a driver has a BAC (blood alcohol concentration) sufficiently high to be in violation of DWI or driving while intoxicated statutes. Some states, as a condition of maintaining a driver's license, require one convicted of a DWI offence to install a system in the driver's vehicle to allow driver BAC to be monitored. The devices serve as an ignition interlock, preventing the vehicle form being started if an excessive BAC is measured. The device may also require the driver to submit breath samples periodically while the vehicle in in operation.

In addition to use as an automotive interlock device, there is a need for a breath monitoring apparatus that is portable and not integrated into other devices, such as a vehicle. A portable device can accompany a user/subject, allowing testing to be performed at any location and time desired.

### BRIEF DESCRIPTION OF THE INVENTION

A test unit apparatus in accordance with the present invention is configured to be portable so that it may function both as an automotive interlock device as well as a transportable testing unit. It provides, in addition to a breath sensing system, functionality for the wireless transmission of test data to a remote monitoring station. It further may include GPS location functionality as well as technology, such as biometric and/or photographic, to provide an identification of an individual user or test subject. The identification system may be utilized independently of the breath testing system, allowing the location of the user to be verified and his/her location at a given time to be verified.

### DESCRIPTION OF THE DRAWING

FIG. 1 is a block diagram of the main components of the invention and their interconnection.

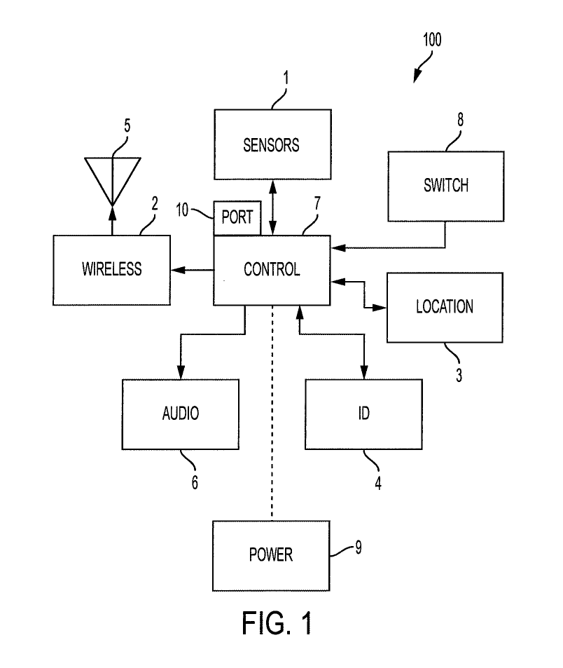

### DETAILED DESCRIPTION OF THE INVENTION

The present invention 100 can be generally characterized as an apparatus comprising seven main systems or modules; a breath sampling and analysis module 1; a wireless communication module 2; a location-determining module 3; a biometric or photographic data acquisition and identity analysis module 4; an antenna module 5; a speech/tone generation module 6; and a control module 7 to integrate and interconnect the other systems. In addition a power supply 9 is provided to supply operating electrical power to the modules as required. The housing for the apparatus is preferably a portable carrying case with water proofing features to protect the equipment when the device is not in use or moved from location to location. Power supply 9 may be a 12 volt system which can be either be powered by 115 VAC mains power and/or include an internal battery pack, preferably with a charging circuit to allow the battery pack to be refreshed from mains power when needed. The power supply can also be provided with a jack to permit operation of the apparatus from an external 12 volt source, such as a car battery, allowing the apparatus to be used inside an automobile, boat etc. without depleting the internal battery pack and allowing recharge from the external source.

The breath sampling and analysis module 1 includes one or more sensors and associated circuitry to measure the concentration of the compound(s) to be monitored, be it alcohol, metabolized drugs or the like. As known in the art, a sample to be analyzed is an exhaled breath, blown by the user into a mouthpiece, tube or other collection device that directs the breath sample to the sensor. Conventional technology as known in the art may be utilized for such detection functionality. As the measure of a breath-contained compound is dependent on the size of the breath sample, the sampling and analysis unit preferably includes means to measure the amount of air the subject has exhaled. This may be a pressure sensor that detects back pressure in a (breath collection) tube of known size. The back pressure is proportional to the amount of air exhaled, and thus provides an accurate measure of the breath sample volume. The relationship can be represented by the equation p₁−p₂=½ρ(V₂²−V₁²), where

p₁ is the inlet pressure;

p₂ is the outlet pressure;

V₁ is the inlet velocity

V₂ is the outlet velocity; and

ρ is the air density.

It can be further shown that the volumetric flow rate is a function of the back pressure:

Φ=dV/dt=vπr²=(πr⁴(p₁−p₂)/8pl)×((p₁−p₂)/2p₂=ρπr⁴/16pl(p₁²−p₂²)/p₂, where

Φ is the volumetric flow rate;

V is the volume;

v is the velocity in the tube;

r is the tube radius; and

l is the tube length.

Thus the volume of the breath sample passing through the tube can be expressed as a function of the pressure drop through the tube and the sample time. Depending on the nature of the sensor employed, one skilled in the art can determine the required volume of air needed to pass the sensor for a proper measurement. By proper tube design the back pressure can be held constant or kept above a known minimum value for a given amount of sample acquisition time so that the amount of air exhaled during that time can be determined. The design of the tube is not critical, but the flow rate and back pressure must be considered. If the tube diameter is too small the subject would have to provide the breath sample over an unrealistically long time. If the tube diameter is too large not enough back pressure would be built up to be measurable.

Control over the sensor system is maintained by control module 7, which initiates the test, monitors the breath flow and test duration and processes the results. It may also initiate an audible indication, to be generated by the speech system module 6, to start a sampling and to provide feedback to the subject during the exhaling process to indicate that the supplied breath pressure is above the minimum quantity necessary to assure that the required minimum amount of air sample is acquired.

While the breath sampling and analysis module may be located within the main housing, at least a portion of the module, comprising the breath collection portion and the sensor system, is preferably embodied in a hand-held unit and connected to the control unit through a multiconductor cable that provides power and signal paths to and from the module components in the hand-held unit. Alternatively and preferably, a hand-held breath sampling and analysis unit can be connected to the control module through Bluetooth technology or other wireless means. In this case a rechargeable battery is incorporated into the hand-held unit to provide power. The wireless signals to and from the hand held unit may be multiplexed using either time division multiplexing or another method. An external charger may also be provided to allow the battery in the hand-held unit to be recharged when needed. The control module 7 can monitor the battery level and provide an audible signal through the speech system module 6 to indicate to the subject that the battery needs recharging. In a likewise manner the control system module monitors the overall state of the battery power supply and provides recharge notifications.

The control module 7 comprises a microprocessor, control circuits and memory for data storage and logging, as well as interfaces for the other modules. Employing techniques as known in the art. For operating simplicity, few user- or subject-operated controls are present, although full access to the processor may be provided through a data port 10 allowing the connection of external units, such as a keyboard and display, to program and troubleshoot the module and overall apparatus as needed. One control that may be present is a switch or push button 8 on a front panel of the apparatus to be used by the subject to prepare the device for the receipt of a breath sample. When the system is properly booted up an appropriate voice command may be issued by speech system module 6. Programming of the control module 7 may provide for a variety of test and sampling scenarios to be initiated. The system may, for example, provide for various alternative test protocols to be carried out. As an example, the apparatus can be programmed to request and accept a breath sample with each activation of the switch 8, thus placing the timing of a test solely within the user or subject's control. Alternatively, the apparatus may be programmed to periodically request breath samples once the apparatus is activated. When the apparatus is programmed to request periodic samples, the speech system 6 can provide audible alerts and tones to the subject that indicate when a breath sample should be provided, the outcome of the test and other messages that may be appropriate. Typically, the choice of test protocol will not be under the subject's control, but will be programmed for use by a service technician or other authorized personnel.

The control module 7 allows data retained in system memory to be transmitted to a remote receiver system through wireless communication module 2. The data is preferably sent in real time upon collection, but can be stored on-board and sent on a delayed basis. However, “real time” data may not be in true real time because of necessary data queuing that can delay the transmission of each event's data to be sent. Information to be delivered may include location data provided by location determination module 3, which may be GPS circuitry incorporated into the wireless communications module 2 or a separate GPS receiver. The location-determining module 3 may further provide means for position locating when necessary GPS beacon signals are inaccessible. In such a case information with respect to position orientation and timing can only be gathered through a self-contained measurement system.

Accordingly, the location-determining system 3 may further incorporate a local clock, which may be provided as part of the control module 7, and inertial sensors consisting of accelerometers and gyroscopes. As known in the art, by tracking the current angular velocity and linear acceleration of the apparatus it is possible to determine the linear acceleration of the apparatus in an inertial reference frame. Performing integration on the inertial accelerations will give the inertial velocities. A second integration will give the inertial position. A self-contained device that incorporates these as well as the required processing is referred to as a TIMU (Timing & Inertial Measurement Unit). Miniature accelerometers already are prevalent in the industry. The gyroscopic portion of the system may incorporate a hemispherical resonator gyroscope (HRG). Reliance on such a “secondary” position-determining system, however, may only be of value for short periods of time due to integration drift. Small errors in acceleration and angular velocity measurement will be integrated into progressively larger errors in velocities, which themselves will be compounded into still greater errors in position. Since a new position is calculated from a previous-calculated position and the measured acceleration and angular velocity, errors accumulate roughly proportional to the time from which the initial position was obtained from the GPS receiver.

A proposed implementation of the TIMU in association with a GPS is as follows. With the GPS receiver located locally in the device circuit, a signal from the receiver which indicates a loss of satellite signal is sent to the control unit 7. The control unit's processor then uses data from the TIMU to continue plotting location information. Alternatively, the onboard TIMU can constantly provide relative position information to the remote server concurrently with location information developed by the GPS receiver. When the external GPS receiver loses satellite communication, the nature of the transmitted position data (such as longitude and latitude), sent to the server will indicate a loss of signal, such as by all zero coordinates. When the zero data is received by the server it will start using the remotely sent TIMU data to continue plotting map information, starting from the last location provided by the GPS. Potential improvement in position accuracy derived from TIMU data can be based on estimation theory or more specifically Kalman filtering, which can be used as a framework for combining the information from the GPS receiver and TIMU. By properly combining and comparing the information from both systems, errors in position and velocity developed by the TIMU can be stabilized and accounted for. Again, however, such methods are only intended as short term solutions when GPS signals are not available.

The biometric or photographic data acquisition and identity analysis module 4 is adapted to allow the identity of the subject providing a test sample to be determined. It may comprise a camera, which may be located either on the main housing for the apparatus and aimed to focus on the subject while in position to provide a breath sample, or on a hand-held breath collection unit if used. Logic utilizing facial detection software may be provided to insure that a “head shot” of the subject can be captured at the time the breath sample is received. If the subject is not properly framed by the camera, an appropriate audible signal can be generated to require repositioning before a breath sample is accepted.

The apparatus's control module processor may also contain facial analysis software that develops information regarding facial features of the subject as captured by the camera. The data is then sent to the remote server, which can conduct further processing and analysis of the data, comparing the data to data stored for an intended subject from an initial picture that was taken at the time of installation of the device. As known, a facial recognition algorithm typically will identify facial features by extracting landmarks, or features, from an image of the subject's face. For example, the algorithm may analyze the relative position, size, and/or shape of the eyes, nose, cheekbones, and jaw. This analysis may be performed by the control unit 7, with the resulting data being encoded and sent to the remote server. Alternatively, the raw facial data itself may be transmitted to the server with analysis being performed at the receiving end. The identified features can then be used to search for other images with matching features. Proper positioning of the subject with respect to the camera is important, as the processing algorithms typically allows for no more than a 20° variation from the normal to the subject face. Other impediments to an accurate analysis typically include the presence of sunglasses, long hair, or other objects partially covering the subject's face, as well as the use of low resolution images, although the last issue may be overcome by the use of a higher resolution camera.

Another identification method which has recently become available utilizes a scan of the subject's blood vessels in the eye. Cellular telephones can be provided with programming (an “app”) that conducts the scan via the camera telephone and creates the appropriate data file. In one embodiment, a cellular telephone so equipped would be incorporated into analysis system 4, transmitting the scan data via a Bluetooth connection to the main unit of the apparatus, which in turn would communicate the data through control unit 7 and wireless communication unit 2 to a remote server for further processing and comparison. This type of technology, however, typically requires holding the cellular telephone in close proximity to the face, usually within 6″ to 12″, and cannot function in low ambient light conditions.

The present apparatus is adapted to communicate breath test results, position information and other collected data to a remote location through the wireless communications module 2. The equipment at the remote location can consist of a computer or server that is capable of processing the incoming data, storing it and making it available for viewing, either at the remote location or at other facilities by further transmission. The data may be available, for example, to authorized personnel on a secure website. The receiving equipment may also be equipped to communicate through text messaging or like events that an interested party may need on an urgent or immediate basis. It is to be appreciated that the time that it takes for information to be received may be dictated by the constraints of queued data as well as delays in the communications circuits. The receiving computer or server can also be connected to a voice synthesizer and telephone dialer to allow this information to be sent over a cellular, wireless, satellite or hard wired telephone connection.

As presented and described, the present invention allows the monitoring of a subject for the presence of particular compound in the subject breath through a portable unit that can be carried by the subject or brought to the subject's location, wherever it may be. The collected data is delivered wirelessly to a remote station for further processing as may be required and action based on the data initiated.

We claim:

1. A portable apparatus for the receipt and analysis of breath-carried components, comprising;
a) a sensor module for receiving breath samples for a subject and detecting the presence of a component to be monitored;
b) a module for monitoring and determining the location of the apparatus;
c) a module for the acquisition of characteristics of the subject and processing them into a form that allows comparison to a database of individuals and their characteristics;
d) a module for generating audible status and operating command signals for the apparatus;
e) a wireless communication module and an antenna module for transmitting data from the apparatus to a remote receiver; and
f) a control module coupling and controlling the other modules of the apparatus into a operable breath analysis system.

2. The apparatus of claim 1 wherein the location monitoring and determination module is a GPS receiver.

3. The apparatus of claim 2 wherein the location monitoring and determination module further comprises a TIMU unit.

4. The apparatus of claim 1 wherein the characteristics acquisition module comprises at least one of a facial recognition system and a retina scan system.

5. The apparatus of claim 1 comprising a main housing for modules b through f, and a hand held housing for module a.

6. The apparatus of claim 5 wherein unit a is operatively connected to unit f wirelessly.

7. A method for analyzing the presence of a desired component in a human breath, comprising the steps of:
a) receiving a breath sample from a subject by a sensor module adapted to sense the presence of the desired compound and analyze the sample for the desired compound;
b) determining whether the breath sample qualifies as a valid sample and if so, keeping results of the analysis;
c) obtaining identity information from the subject by photographic means concurrently with the receipt of the breath sample;
d) obtaining location information for the sensor module concurrently with the receipt of the breath sample;
e) wirelessly transmitting the analysis results, identity information, and location information to a remote receiver; and
f) processing the transmitted information to generate a record of the identity and location of the subject along with the analysis results.

8. The method of claim 7 wherein location information is obtained by way of a GPS receiver and a TIMU unit.
